(19) United States
(12) Patent Application Publication
(10) Pub. No.: US 2014/0333869 A1
(43) Pub. Date: Nov. 13, 2014

(54) Structure For Adjusting Gap Between Liquid Crystal Module and Middle Frame, And Liquid Crystal Display Device

(71) Applicant: Shenzhen China Star Optoelectronics Technology Co. Ltd., Shenzhen, Guangdong (CN)

(72) Inventor: Guofu Tang, Shenzhen City (CN)

(21) Appl. No.: 13/981,945

(22) PCT Filed: Jun. 25, 2013
(86) PCT No.: PCT/CN2013/077893

§ 371 Date: Jul. 26, 2013

(30) Foreign Application Priority Data
May 9, 2013 (CN) 201310169386.4

(51) Int. Cl. G02F 1/1333; G02F 1/1339

(52) U.S. Cl. CPC G02F 1/133308; G02F 1/1339; G02F 2001/133317; G02F 2001/133314
USPC 349/60

(57) ABSTRACT

The present invention provides a structure for adjusting gap between liquid crystal module and middle frame of a liquid crystal display device, which comprises: a liquid crystal module, a middle frame and a back frame, wherein a horizontal wall of the middle frame carrying the liquid crystal module and a connector being disposed between a vertical wall the back frame and a resilient device being disposed between the vertical wall and the back frame. Through providing a resilient material between the middle frame and the back frame for adjustment, the present invention enables the convenience of liquid crystal module assembly and achieves the rapid assembly as well as good result for fine adjustment.

### BACKGROUND OF THE INVENTION

1. Field of the Invention

The present invention relates to the field of liquid crystal display techniques, and more particular to a structure for adjusting gap between liquid crystal module and middle frame of a liquid crystal display device.

2. The Related Arts

The structure of a conventional liquid crystal display is shown in FIG. 1. The front frame 1 is mainly for pressing the liquid crystal module 2 to prevent the liquid crystal module 2 from disengagement. As the displaying technique develops, the width of front frame 1 becomes smaller and become an ultra-narrow frame. The horizontal wall 4 of a middle frame 3 is for carrying the liquid crystal module 2 and the vertical wall 5 is for positioning the liquid crystal module 2. The middle frame 3 usually uses hooks or screws to position with back frame 6. Because the manufacturing error or assembly error of the middle frame and the back frame, a gap A must be reserved between the vertical wall of the middle frame and the edge of the liquid crystal module to avoid the difficulty of disposing the liquid crystal module inside the middle frame caused by the series of errors. The larger the size of the display is, the larger of the gap A must be reserved. For example, a 0.3 mm gap must be reserved for a 32-inch, but a gap between at least 0.5 mm must be reserved for a 55-inch and more. The gap is bad for further reducing the width of ultra-narrow frame.

### SUMMARY OF THE INVENTION

The technical issue to be addressed by the present invention is to provide a structure for adjusting gap between liquid crystal module and middle frame of a liquid crystal display device.

The structure for adjusting gap between liquid crystal module and middle frame of a liquid crystal display device comprises: a liquid crystal module, a middle frame and a back frame, wherein a horizontal wall of the middle frame carrying the liquid crystal module and a connector being disposed between a vertical wall the back frame and a resilient device being disposed between the vertical wall and the back frame.

According to a preferred embodiment of the present invention, the resilient device is made of a buffering material, through adjusting the connector to change distance between the middle frame and the back frame so as to achieve adjusting gap between the liquid crystal module and the middle frame.

According to a preferred embodiment of the present invention, the buffering material is attached to the middle frame and/or back frame.

According to a preferred embodiment of the present invention, the resilient device is a metal resilient plate, wherein the metal resilient plate is fixed to the middle frame or the back frame.

According to a preferred embodiment of the present invention, the metal resilient plate has a structure with one end of the metal resilient plate fixed to the middle frame or the back frame and the other end bouncing outward.

According to a preferred embodiment of the present invention, the metal resilient plate has a U-shape, sheathed at the back frame, with a side facing towards the middle frame being the other end bouncing outward.

According to a preferred embodiment of the present invention, the U-shape metal resilient plate comprises a back, a bridge, a front connecting part, a transition part, a resilient part, connected in series and formed monolithically, wherein the back, the bridge and the front connecting part being tightly sheathed at the back frame, the transition part extending outward and the resilient part contacting the middle frame surface.

According to a preferred embodiment of the present invention, the resilient part comprises a plurality of plate contacting bodies arranged in a side-by-side manner to enhance contact effect.

According to a preferred embodiment of the present invention, the connector is a step-wise screw and the middle frame is disposed with a corresponding sink hole, wherein the distance from the screw cap to the back frame is larger than the depth of the sink hole.

Another object of the present invention is to provide a liquid crystal display device, which comprises a liquid crystal display module, a middle frame, and a back frame, wherein the liquid crystal display module comprises a liquid crystal module and a backlight module and further comprises a structure for adjusting gap between liquid crystal module and middle frame of a liquid crystal display device, which comprises: a liquid crystal module, a middle frame and a back frame, wherein a horizontal wall of the middle frame carrying the liquid crystal module and a connector being disposed between a vertical wall the back frame and a resilient device being disposed between the vertical wall and the back frame.

According to a preferred embodiment of the present invention, the resilient device is made of a buffering material.

According to a preferred embodiment of the present invention, the buffering material is attached to the middle frame.

According to a preferred embodiment of the present invention, the buffering material is attached to the back frame.

According to a preferred embodiment of the present invention, the resilient device is a metal resilient plate, wherein the metal resilient plate is fixed to the back frame.

According to a preferred embodiment of the present invention, the metal resilient plate has a structure with one end of the metal resilient plate fixed to the middle frame or the back frame and the other end bouncing outward.

According to a preferred embodiment of the present invention, the metal resilient plate has a U-shape, sheathed at the back frame, with a side facing towards the middle frame being the other end bouncing outward.

According to a preferred embodiment of the present invention, the U-shape metal resilient plate comprises a back, a bridge, a front connecting part, a transition part, a resilient part, connected in series and formed monolithically, wherein the back, the bridge and the front connecting part being tightly sheathed at the back frame, the transition part extending outward and the resilient part contacting the middle frame surface.

The efficacy of the present invention is that to be distinguished from the state of the art. Through providing a resilient material between the middle frame and the back frame for adjustment, the present invention enables the convenience of liquid crystal module assembly and achieves the rapid assembly as well as good result for fine adjustment.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the partial structure of a known liquid crystal display device;

FIG. 2 is schematic view showing a partial structure of a first embodiment of the present invention;

FIG. 3 is a schematic view showing another partial structure of a second embodiment of the present invention;

FIG. 4 is a schematic view showing a partial structure of a third embodiment of the present invention;

FIG. 5 is a schematic view showing a partial structure of a fourth embodiment of the present invention;

FIG. 6 is a schematic view showing a structure of the metal resilient plate of the fourth embodiment of the present invention; and

FIG. 7 is a schematic view showing a partial structure of a liquid crystal display device without front frame of a fifth embodiment of the present invention.

### DETAILED DESCRIPTION OF THE PREFERRED EMBODIMENTS

The following refers to the drawings and embodiment to describe the present invention in details.

### First Embodiment

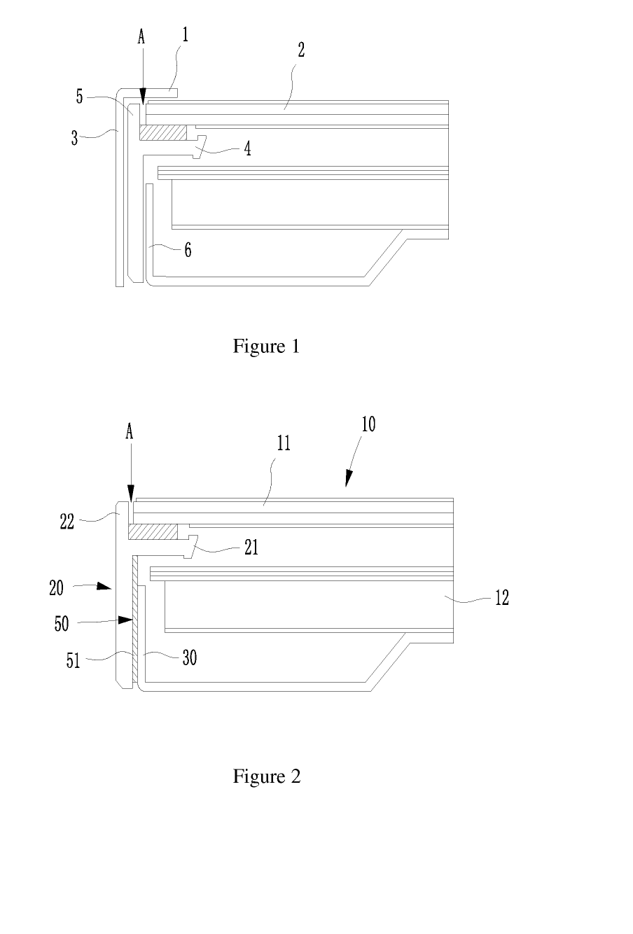

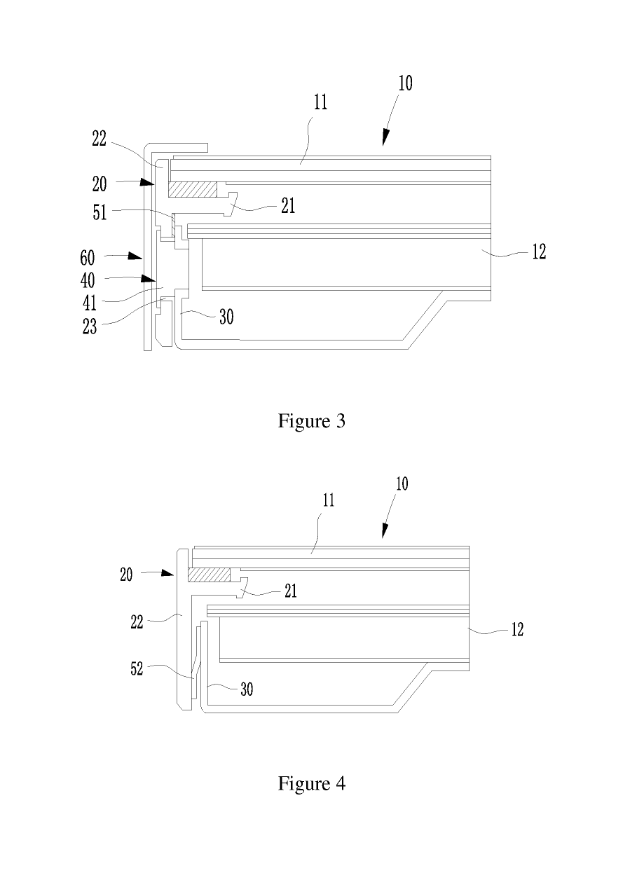

As shown FIG. 2, a structure for adjusting gap between liquid crystal module and middle frame according to the present invention comprises a liquid crystal display module 10, a middle frame 120 and a back frame 30. The liquid crystal display module 10 further comprises a liquid crystal module 11 and a backlight module 12, wherein a horizontal wall 21 of the middle frame 20 is to carry the liquid crystal module 11 and a connector 40 is disposed between a vertical wall 22 of the middle frame 20 and the back frame 30 (same as the partial structure shown in FIG. 3). It is worth noting that a resilient device 50 is disposed between the vertical wall 22 and the back frame 30. The resilient device is made of a buffering material 51. In the instant embodiment, the buffering material 51 can be an SCF foam material, which is attached to any one or both of the middle frame or the back frame in advance. Through adjusting the connector 40, the tightness between the middle frame 20 and the back frame 30 can be adjusted so as to achieve the fine adjustment of a gap A between the vertical wall of the middle frame 20 and the edge of the liquid crystal module 11.

### Second Embodiment

As shown in FIG. 3, the difference is that the instant embodiment is applied to a liquid crystal display device with a front frame 60 and the connector 40 is a step-wise screw. A corresponding sink hole 23 is disposed at the middle frame for the step-wise screw. The distance from the screw cap 41 to the back frame 30 is larger than the depth of the sink hole to fully exploit the resilience of the buffering material to perform fine adjustment of the gap between the middle frame and the liquid crystal module so that a 0.1-0.2 mm gap can be reserved between the vertical wall at the upper part of the middle frame and the edge of the liquid crystal module to achieve narrower side frame.

### Third Embodiment

As shown in FIG. 4, the difference between the instant embodiment and the previous embodiment is that the resilient device is a metal resilient plate 52. The metal resilient plate 52 is fixed to the back frame 30. As shown, the metal resilient plate 52 has a structure with one end fixed to the back frame 30 and the other end bouncing outward. When the middle frame 20 is drawn to the back frame 30 under the effect of the screw (not shown) and presses the metal resilient plate, through the connector 40 to adjust the distance between the middle frame 20 and the back frame 30, the distance between the middle frame 20 and the vertical wall 22 can be further reduced after the liquid crystal module 11 is positioned.

### Fourth Embodiment

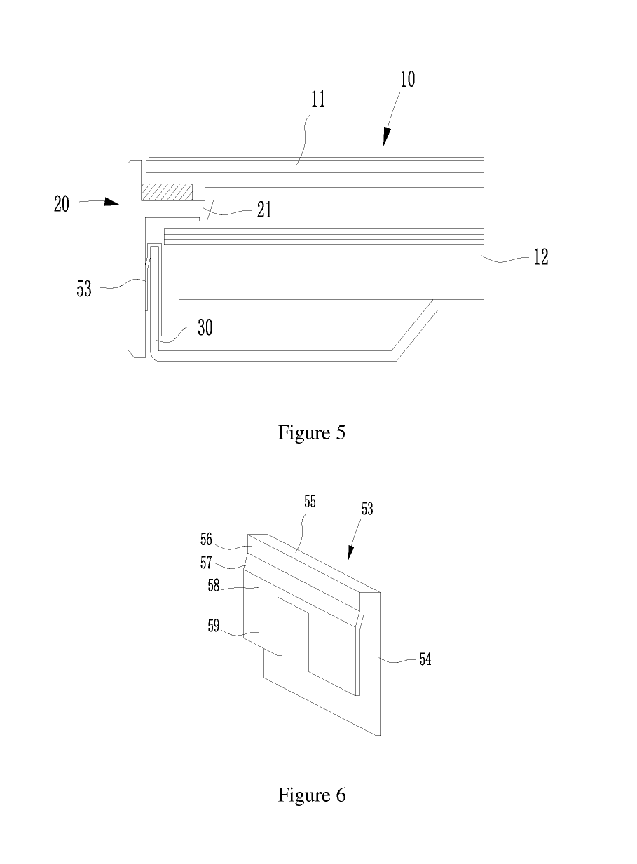

The instant embodiment is shown in FIG. 5 and FIG. 6. The difference from the third embodiment is the metal resilient plate. The metal resilient plate 53 is mainly a U-shape, sheathed at the upper part of the back frame 30, wherein one side of the metal resilient plate facing the middle frame 20 is a structure bouncing outward. As shown, the U-shape metal resilient plate comprises a back 54, a bridge 55, a front connecting part 56, a transition part 57, a resilient part 58, connected in series and formed monolithically, wherein the back 54, the bridge 55 and the front connecting part 56 are tightly sheathed at the back frame, the transition part 57 extends outward and the resilient part 58 contacts the middle frame 20 surface. To further enhance the contacting effect, the resilient part 58 is designed to comprise a plurality of plate contacting bodies 59 arranged in a side-by-side manner. The figure shows two plate contacting bodies 59, with a trench formed by stamping at the middle. The U-shape metal resilient plate 53 is directly sheathed at the back frame and convenient for assembly.

### Fifth Embodiment

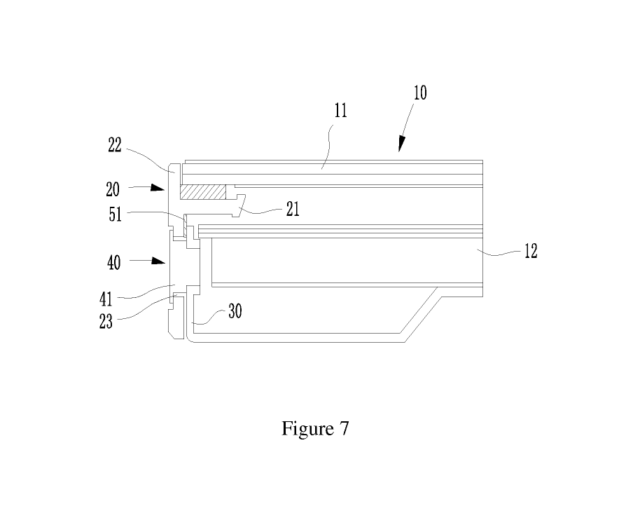

The difference of the gap adjustment structure in the instant embodiment from the second embodiment is that the instant embodiment does not comprise a front frame. As shown in FIG. 7, a sink hole 23 is disposed at the middle frame 20 and the connector 40 is a step-wise screw, with the distance from the screw cap 41 to the back frame 30 larger than the depth of the sink hole 23 to fully exploit the resilience of the buffering material 51 to perform fine adjustment of the gap between the middle frame 20 and the liquid crystal module 11 so that a reserved 0.1-0.2 mm gap between the vertical wall 22 at the upper part of the middle frame and the edge of the liquid crystal module 11 can be maintained.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A structure for adjusting gap between liquid crystal module and middle frame, which comprises: a liquid crystal module, a middle frame and a back frame, wherein a horizontal wall of the middle frame carrying the liquid crystal module and a connector being disposed between a vertical wall the back frame and a resilient device being disposed between the vertical wall and the back frame.

2. The structure for adjusting gap between liquid crystal module and middle frame as claimed in claim 1, characterized in that the resilient device is made of a buffering material.

3. The structure for adjusting gap between liquid crystal module and middle frame as claimed in claim 2, characterized in that the buffering material is attached to the middle frame.

4. The structure for adjusting gap between liquid crystal module and middle frame as claimed in claim 2, characterized in that the buffering material is attached to the back frame.

5. The structure for adjusting gap between liquid crystal module and middle frame as claimed in claim 1, characterized in that the resilient device is a metal resilient plate, wherein the metal resilient plate is fixed to the middle frame or the back frame.

6. The structure for adjusting gap between liquid crystal module and middle frame as claimed in claim 5, characterized in that the metal resilient plate has a structure with one end of the metal resilient plate fixed to the middle frame or the back frame and the other end bouncing outward.

7. The structure for adjusting gap between liquid crystal module and middle frame as claimed in claim 5, characterized in that the metal resilient plate has a U-shape, sheathed at the back frame, with a side facing towards the middle frame being the other end bouncing outward.

8. The structure for adjusting gap between liquid crystal module and middle frame as claimed in claim 7, characterized in that the U-shape metal resilient plate comprises a back, a bridge, a front connecting part, a transition part, a resilient part, connected in series and formed monolithically, wherein the back, the bridge and the front connecting part being tightly sheathed at the back frame, the transition part extending outward and the resilient part contacting the middle frame surface.

9. The structure for adjusting gap between liquid crystal module and middle frame as claimed in claim 8, characterized in that the resilient part comprises a plurality of plate contacting bodies arranged in a side-by-side manner to enhance contact effect.

10. The structure for adjusting gap between liquid crystal module and middle frame as claimed in claim 1, characterized in that the connector is a step-wise screw and the middle frame is disposed with a corresponding sink hole, wherein the distance from the screw cap to the back frame is larger than the depth of the sink hole.

11. A liquid crystal display device, which comprises: a liquid crystal display module, a middle frame, and a back frame, wherein the liquid crystal display module comprises a liquid crystal module and a backlight module and further comprises a structure for adjusting gap between liquid crystal module and middle frame of a liquid crystal display device, which comprises: a liquid crystal module, a middle frame and a back frame, wherein a horizontal wall of the middle frame carrying the liquid crystal module and a connector being disposed between a vertical wall the back frame and a resilient device being disposed between the vertical wall and the back frame.

12. The liquid crystal display device as claimed in claim 11, characterized in that the resilient device is made of a buffering material.

13. The liquid crystal display device as claimed in claim 12, characterized in that the buffering material is attached to the middle frame.

14. The liquid crystal display device as claimed in claim 12, characterized in that the buffering material is attached to the back frame.

15. The liquid crystal display device as claimed in claim 11, characterized in that the resilient device is a metal resilient plate, wherein the metal resilient plate is fixed to the middle frame or the back frame.

16. The liquid crystal display device as claimed in claim 15, characterized in that the metal resilient plate has a structure with one end of the metal resilient plate fixed to the middle frame or the back frame and the other end bouncing outward.

17. The liquid crystal display device as claimed in claim 15, characterized in that the metal resilient plate has a U-shape, sheathed at the back frame, with a side facing towards the middle frame being the other end bouncing outward.

18. The liquid crystal display device as claimed in claim 17, characterized in that the U-shape metal resilient plate comprises a back, a bridge, a front connecting part, a transition part, a resilient part, connected in series and formed monolithically, wherein the back, the bridge and the front connecting part being tightly sheathed at the back frame, the transition part extending outward and the resilient part contacting the middle frame surface.
